(19) United States
(12) Patent Application Publication
(10) Pub. No.: US 2026/0338214 A1
(43) Pub. Date: Oct. 29, 2026

(54) CONNECTION DEVICE FOR THE CONNECTION OF CANTILEVER SEGMENTS OF A CANTILEVER OF A TOWER CRANE

(71) Applicant: Wolffkran Holding AG, Cham (CH)

(72) Inventors: Thomas Heidrich, Heilbronn (DE); Björn-Philipp Hessenmüller, Großbottwar-Winzerhausen (DE); Steffen Hildenbrand, Lehrensteinsfeld (DE); Wolfgang Ingelfinger, Erlenbach (DE); Stefan Reinhard, Brackenheim (DE); Patrick Witteck, Lauffen am Neckar (DE)

(73) Assignee: Wolffkran Holding AG, Cham, OT (CH)

(21) Appl. No.: 18/879,337

(22) PCT Filed: Jun. 28, 2023
(86) PCT No.: PCT/EP2023/067700

§ 371 Date: Dec. 27, 2024

(30) Foreign Application Priority Data
Jun. 30, 2022 (DE) 10 2022 116 387.3
Oct. 21, 2022 (EP) 22203025.6

(51) Int. Cl. F16B 5/02; B66C 23/70

(52) U.S. Cl. CPC F16B 5/025; B66C 23/70

(57) ABSTRACT

A connection device for connecting cantilever segments of a cantilever tower crane includes at least one connection bolt with a first fastening part for fastening to a first pressure plate of a first cantilever segment and a second fastening part for fastening to a second pressure plate of a second cantilever segment. The first fastening member includes a releasable, twist-proof connecting means for fastening to the first pressure plate, and the second fastening part includes a centering mandrel for fastening to the second pressure plate, which has a radial, continuous, securing slot for receiving a plug-in part; a centering sleeve for inserting into a corresponding through-opening in the second pressure plate, which has an internal cross-section for positively receiving the second fastening part.

### FIELD OF THE INVENTION

The present invention relates to a cantilever, i.e. a jib, of a tower crane, in particular a cantilever in the style of a crane element known in the art as a trolley cantilever or trolley carriage. The invention further relates to lower chord connections for the connection of cantilever segments for such a cantilever.

### TECHNICAL BACKGROUND

Cantilevers of tower cranes are usually composed of individual cantilever segments that are detachably connected by means of connection devices. Such cantilevers have at least one lower chord and at least one upper chord, in addition to other constructional features. Lower chords are preferably made of steel tubes having a square profile, upper chords are made of flat steel, steel tubes having a square profile or steel tubes having a round profile. The at least one upper chord serves primarily for the absorption of forces resulting from tensile loads, and is located in the head area of a cantilever segment. The at least one lower chord serves primarily for the absorption of forces resulting from compressive loads, and is located in the foot area of a cantilever segment. The cantilever segments feature connection devices in those areas in which they are connected to each other. These connection devices form the end face closure of the at least one upper chord, or the at least one lower chord for the respective cantilever segment.

Certain layouts of tower crane cantilevers are called trolley cantilevers or trolley carriages since they comprise a track (raceway) and a lateral guide for a deflection device for a hoisting rope which deflection device is known among experts as trolley or crab.

Such cantilevers can also be used within steel construction structures, e.g. for the construction of mobile steel halls or festival halls, or for cantilevers of other crane types, such as mobile harbor cranes or semi-stationary storage yard cranes, insofar as such steel construction structures or crane cantilevers have steel construction or cantilever segments that are connected by means of a connection device, which construction or cantilever segments are based on a truss or lattice structure.

The individual cantilever segments of a tower crane cantilever are usually being connected to each other, i.e., assembled, preferably on the ground before commissioning of the crane. In exceptional cases, cantilever segments are added to the cantilever of a tower crane which is already in operation by means of detachable connection techniques in order to extend the cantilever. Detachable connections therefore have to be suitable for both installation scenarios, and have to be structurally designed accordingly.

The connection techniques used for the build-up of such a cantilever from cantilever segments usually comprise only a few connection elements which are easy-to-handle, maintenance-free, backlash-free as well as low-wear.

A cantilever of a tower crane is known, for example, from EP 1 728 756 B1. This cantilever features a connection device formed by trunnions and centering pins between two cantilever elements, separate recesses receiving these pins and centering pins, as well as fixing elements, which, being in operative connection to each other and with each other, fix the cantilever segments to each other on the one hand, and detachably connect them to each other on the other hand. Among experts, this connection device is also known as Liebherr LiConnect (see “LIEBHERR ECB LiConnect”, website brochure p.18). With such a connection device for lower chords of cantilever segments, a first disadvantage is that the connection device, due to its arrangement, can only absorb the forces via the limited area of the end faces of the lower chords. The cross members of the ECB cantilever located between the bottom chords on the foot side do not transmit any forces within the frontal connection area of the segments since these cross members are not directly tied to each other in the connection area in terms of steel construction, in other words they are not mechanically directly coupled to each other. The wear pattern of a connection device designed by means of the LiConnect concept is accordingly pronounced because the transmitted forces are introduced exclusively in a limited area via the areas of the end faces, which are located outside the trunnion. The resulting load-bearing pattern is distinguished by locally extremely high forces and by correspondingly developing stress peaks.

Furthermore, transverse forces generated by the rotation of the tower crane in the foot area of the cantilever and the resulting moments cannot be completely absorbed by a connection device designed in this way, that is local counter-moments cannot be generated in particular by the trunnion, which can permanently lead to incremental deformations of the cantilever segment in its foot area, but in particular of the connection device. The cantilever construction must therefore be made solid in terms of steel construction in the lower chords and with regard to the integration of these in the truss of the cantilever segment. In this context, a further disadvantage is the relatively complex construction of the connection device, especially in the area of the end terminations of the lower chords (so-called joints) as well as the enclosure of the trunnion, as well as the trunnions themselves, in order to achieve a so-called sealing caulking, i.e., guaranteeing a permanent positive fit of the connection elements and thus of the joints among each other. Opening of the joints during crane operation cannot be permanently avoided despite this high effort in terms of steel construction. In addition, the trunnion wears out within its reception due to friction and dynamic bearing play, which cannot be subsequently adjusted or compensated for and which is why the tolerances of the mount and the trunnion must be narrowly defined from the beginning.

From EP 1 468 955 A1, a tower crane cantilever is known, the end faces of the lower chords of which are designed as cross members, and which extend transversely to the longitudinal axis of the cantilever. The cross members have round cut-outs (bores), of which a first cut-out accommodates a clamping bolt which is fixed by a plug-in part. The plug-in part, which is not fixed in its position, is secured against slipping out by means of a securing catch (cotter pin). A second round cut-out (hole) in the cross member accommodates a centering pin in the end face area of the bottom chords. Within the end terminations of the lower chords, centering pins are placed on the cross member of a lower chord to be connected, which complementarily engage in round cut-outs of the end terminations of the cross member of another lower chord to be connected. These centering pins are designed as cylinders with a stepped section and two directly successive, conically designed areas with different flank pitches, wherein the cylindrical part within the end face section assumes the function of a sealing section.

The detachable connection device between the lower chords is represented by a locking unit consisting of several links, the locking unit being located in spatial proximity to, but at a distance from, the respective end centering pin. Each link unit comprises a clamping bolt which is mounted so as to be displaceable in the longitudinal direction of the cantilever segment parallel to the lower chord, along a carriage welded to the cross member. The respective connecting action between the lower chords is achieved in that the clamping bolt is advanced by sliding along the slide into the round cut-out of the end cross member of the other cantilever section and in that a locking plug-in part is inserted into the head of the clamping bolt. With a connection device for cantilever parts designed in this way, a first disadvantage is that the connection unit can only insufficiently absorb the forces and moments that occur. A further disadvantage is that the end cross members located between the bottom chords at the foot end can only absorb forces locally and to a limited extent within the end connection area of the segments, because these end cross members are not directly coupled to each other over a large area in the connection area in steel construction. Due to their arrangement at a distance from the end face of the lower chords, the connection device primarily absorbs axial bending moments and only to a small degree transverse forces, without being able to generate corresponding bearing forces or counter-moments. The forces acting on the lower chord connection charge between the locations of the frontal fixation and the locations of the connection creation, which in turn results in a greater steel construction effort in order to be able to absorb these diverted forces without deforming the foot-side cantilever area and the connection elements. Another disadvantage is the relatively complex structure of this connection device, which has many elements to be secured against loss.

It is an object of the present invention to further design a detachable connection of cantilever segments in such a way that, on the one hand, it consists of few elements while being simple in design, and is, on the other hand, suitable for absorbing large forces as well as moments acting on the cantilever elements during crane operation. The forces and moments that change during crane operation should ideally be counteracted by forming local, adjustable bearing forces and counter-moments.

### SUMMARY OF THE INVENTION

This problem is solved by a connection device for a cantilever segment according to claim 1, as well as according to the dependent claims.

Further embodiments are given in the dependent claims.

According to a first aspect, a bottom chord connection is provided with a connection device, in particular for connecting cantilever segments of a cantilever of a tower crane, comprising:
at least one connection bolt with a first fastening part for fastening to a first pressure plate of a first cantilever segment and with a second fastening part for fastening to a second pressure plate of a second cantilever segment,
wherein the first attachment member is provided with a releasable, twist-proof connecting means for attachment to the first pressure plate,
wherein the second fastening part is provided with a centering mandrel for fastening to the second pressure plate, which has a radial, in particular continuous, securing slot for receiving a plug-in part;
at least one centering sleeve for inserting into a corresponding through-opening in the second pressure plate, which has an internal cross-section in order to positively receive the second fastening part.

In particular, the first through-opening located in the first pressure plate, which is present at least once, can be designed in such a way as to receive the connection bolt in a form-fitting manner, in particular in the axial and radial direction of a through-opening. In particular, the through-opening located in the second pressure plate can be designed in such a way that the centering sleeve can be received in a form-fitting and friction-locking manner in the axial and radial direction of the through-opening in the second pressure plate.

Consequently, the connection device according to the invention is distinguished in particular by the fact that its elements advantageously combine the function of a fixed screw connection having the function of a detachable plug-in connection by means of adjustable centering and fixing elements.

The proposed connection device mainly uses standard parts with a few special parts in an operative connection, wherein a high degree of standardization and calculability is achieved in the design of the individual elements and thus ultimately a high functional reliability of the cantilever.

In order to increase the rigidity in the lower chord area, it has also been found to be advantageous if the lower chords of the cantilever segment are connected to each other at the end preferably via at least two pressure plates. By creating a flat contact between the at least two pressure plates, which close the front sides of the cantilever segments in their foot areas, these take over the function of two mechanically connected cross members. The lower chords are tied together in steel construction by means of these cross members, which can have the same external geometry and can thus cause a duplication of the cross sections absorbing forces and moments in the foot area of the cantilever segments. The construction of the cantilever segments is thus stiffened in an area where maximum bending and shear forces as well as moments act on the bottom chords.

By means of the pressure plates integrated in the frontal foot area of the cantilever segment, a maximum effective transmission area can thus be formed, via which the connection between the lower chord areas of two cantilever segments is established and which is not only located in the limited area of the surfaces directly in the area of the frontal terminations of the lower chords, but via a maximum frontal foot area which extends in a plane forming transversely or at an angle to the longitudinal axis of the cantilever.

Furthermore, it is advantageous if the connection device comprises at least one connection bolt, which is preferably made in one piece and rotationally symmetrical, a first through-opening located in a first pressure plate and receiving the connection bolt, a centering sleeve arranged between the connection bolt and a second through-opening of a second pressure plate, and a plug-in part.

The elements of the connection device mounted on the cantilever segments to be connected complement each other. For this purpose, a first cantilever segment has a first pressure plate in the foot area of its front end. This first pressure plate receives the connection device by means of which a second pressure plate is connected which is present in a second cantilever segment to be connected. The first and second pressure plates connected by the connection device are predominantly in contact with each other, and any frictional contact between the first and second pressure plates can be neglected when determining the connection forces generated between the cantilever segments by means of the connection device.

Provision can be made that the first fastening part has a second cylindrical lateral surface section which, in particular, directly adjoins the second fastening part. In particular, the first fastening part can have a screw-threaded section which adjoins the second cylindrical lateral surface section in order to fasten the first fastening part to the first pressure plate by screwing. The second cylindrical lateral surface section can be provided with an anti-rotation device, which is in particular formed with a centering pin projecting from the second cylindrical lateral surface section. In order to accommodate several connection bolts in the same direction according to a preferred embodiment of the connection device, it has proven advantageous if the first pressure plate has several first through-holes and the second pressure plate several corresponding second through-holes. In this case, the identical (preferably parallel with respect to their longitudinal directions) orientation of the mounted connection bolts is to be understood by simultaneous reception, in such a way that the connection bolts located in and on the pressure plates point in the same direction.

Provision can be made that at least one further connection bolt is provided with a first fastening part for fastening to the second pressure plate of the second cantilever segment and with a second fastening part for fastening to the first pressure plate of the first cantilever segment, wherein the first fastening part is provided with a releasable connection device for fastening to the second pressure plate, wherein the second fastening part is provided with a centering mandrel for fastening to the first pressure plate, which centering mandrel has a radial, in particular continuous, securing slot for receiving a plug-in part, and a centering sleeve is provided for inserting into a corresponding through-opening in the first pressure plate, which centering sleeve has an internal cross-section for receiving the second fastening part in a form-fitting manner.

In order to accommodate several connection bolts in an alternating manner according to a further conceivable embodiment of the connection device, it has turned out to be advantageous if the first and the second pressure plate each have at least one first through-opening and at least one second through-opening. The term “alternating mounting” refers to the orientation of the connection bolts in such a way that at least two of the connection bolts located in and on the pressure plates point in opposite directions.

The at least one, first through-opening can be widened in its upper area in terms of a slot in order to accommodate a centering pin, which advantageously fixes the connection bolt against rotation during its screwing to the pressure plate. This ensures that the insertion of the plug-in part into a securing slot located in the head of the connection bolt can always be carried out vertically from above, which is an advantage when assembling the cantilever segments on the ground side on the construction site and in particular when assembling the cantilever segments during crane operation, sometimes at airy heights. The connection bolt is provided on one end in a first section (screw thread section), distinguished by a first cross-section, in particular with a metric thread of normal pitch.

A second section of the connection bolt has a first shoulder immediately adjacent to the first section (screw thread section), from which the first cross-section of the connection bolt widens to a second cross-section of the connection bolt. The first and second sections form the first fastening part of the connection bolt. Between the first cross-section of the connection bolt and the second cross-section of the connection bolt, a first contact area is formed which can also be a non-round shape and which has a first chamfer in its upper region. By means of this chamfer, an easier threading of the connection bolt into the at least one first through-opening of the first pressure plate is made possible, which is particularly beneficial for the assembly of the connection bolt.

The second section (second cylindrical lateral surface section) of the connection bolt is distinguished by a first lateral surface in which a bore is let in to receive a centering pin. When threading the connection bolt, this centering pin is received in a slot which serves to radially fix the connection bolt in extension of the at least single first through-opening of the first pressure plate.

During assembly, the first and second sections of the connection bolt are inserted into the at least one first through opening of the first pressure plate. A lock washer is placed on the part of the first section (screw thread section) protruding from the mounting side of the first pressure plate and ensures a flat contact of a crown nut screwed onto the screw thread section on the mounting side of the first pressure plate. This advantageously ensures that the screwing forces are evenly and predictably applied to the mounting side of the first pressure plate over a large cross-section.

The lateral surface of the second section of the connection bolt ends at a second shoulder and, by its full-surface contact in the at least one first through-opening of the first pressure plate, ensures on the one hand a radial fixation of the connection bolt in the first pressure plate and on the other hand a low-backlash connection between the connection bolt and the first pressure plate.

Beginning with the second shoulder, a third section (first cylindrical lateral surface section) of the connection bolt extends from which the second cross-section of the connection bolt widens to a third cross-section of the connection bolt. Between the second cross-section of the connection bolt and the third cross-section of the connection bolt, a second contact area is formed, which lies directly against the end face of the first pressure plate. By means of this second contact area, both an axial contact of the connection bolt and a transmission of the axial pretensioning forces, which are set up by the connection bolt, to the end face of the first pressure plate are effected.

The third section (first cylindrical lateral surface section) of the connection bolt is distinguished by a second lateral surface. This lateral surface merges into a fourth section of the connection bolt, which is referred to as the head section. The third and fourth sections form the second fastening part of the connection bolt.

Furthermore, the connection bolt can have in its head region a section tapering towards the second fastening part and adjoining a first cylindrical lateral surface section, the first cylindrical lateral surface section being receivable in a mounted state in the centering sleeve, in particular in a form-fitting manner.

The tapered section in the head area of the connection bolt can be distinguished by a third lateral surface, which is designed as a cone and thus forms a centering pin. The centering pin opens into a second chamfer, which also forms the other end of the connection bolt.

The second chamfer, together with the surface of the cone of the centering pin of the connection bolt, facilitates the insertion of the connection bolt as well as the centering sleeve into the at least one second through opening of the second pressure plate. This considerably facilitates the assembly of cantilever segments to be connected, which is particularly beneficial for safe handling and assembly of the same.

A further advantage of the novel connection device for a lower chord connection is given in particular by the introduction of a centering sleeve. For this purpose, provision can be made that the centering sleeve has a completely or partially circumferential flange which can be provided at an axial end of the centering sleeve and is arranged in the direction of the second fastening part in an assembled state. This centering sleeve can thus be designed as a collar bushing, and is distinguished by a first sleeve section which has the shape of a tube, which does not necessarily have to be round, and has an inner wall and an outer wall with an intermediate surface which does not necessarily have to be designed as an annular surface. At a first end of the first sleeve section, a chamfer can be arranged between the surface and the inner wall, which, as an insertion aid complementary to the cone of the centering pin of the connection bolt, facilitates the insertion of the centering sleeve onto the second lateral surface of the connection bolt.

At a second end of the first sleeve section of the centering sleeve there is an undercut to which a second sleeve section of the centering sleeve is connected. This second sleeve section is distinguished by a circumferential flange with an inner and outer flange area. The flange areas of the flange thus have a first and a second bearing surface as well as an inner diameter and an outer diameter and thus give this second sleeve section the shape of a collar. This collar is cut off on one side at the outer cross-section, which allows more leeway in the structural steel design of the cantilever segment.

The centering sleeve is arranged, as described above, between the lateral surface of the first cylindrical lateral surface section of the connection bolt and the wall of an at least single second through-opening located in the second pressure plate. For this purpose, the centering sleeve is dimensioned in the axial and radial direction in such a way that it achieves full-surface support over a maximum contact area on the one hand for the second lateral surface of the connection bolt and on the other hand for the wall of the at least single second through-opening of the second pressure plate. By means of an undercut between the first and the second sleeve section of the centering sleeve, a flat and shoulder-free contact of the centering sleeve can be created by an inwardly directed undercut radius between the first and the second sleeve section of the centering sleeve.

Both the centering sleeve and the at least one second through-opening of the second pressure plate can be structurally designed in their cross sections or diameters in such a way that, in interaction, they satisfy the design of a clearance fit. In this way, these two elements ensure, on the one hand, an optimal transmission of the radial forces acting on the centering pin and, on the other hand, the absorption of the moments acting on the length of the centering pin clamped in the second pressure plate. When manufacturing the centering sleeve as a turned part, close tolerances should be applied to the dimension of the outer wall of the first sleeve section of the centering sleeve so that it has a minimized clearance in its installed position relative to the wall of the at least one second through-opening.

A further advantage of the connection device can be in particular the axial force application via the engaged inner and outer contact areas of the centering sleeve in the second sleeve section, by means of which the axial pretension caused by the centering pin and the plug-in part enables a uniform and maximum surface pressure between the first and the second pressure plate. In cooperation with the bending-resistant centering pin, the elastic centering sleeve as well as the elastic pressure plates result in an improved bending, transverse force and moment absorption as well as an optimized restoring behavior of the connection device.

A further advantage of the centering sleeve can consist in particular in its design of a completely or partially circumferential flange, which can be designed as a collar as described previously. The collar located in the second sleeve section is distinguished in particular by an inner and outer flange area. The bearing surface forming between the inner diameter and the outer diameter of the collar can be designed depending on the area and thus the surface-related resistance of the first and second pressure plates. Due to their radial and planar contact in the first and second sleeve section, the centering sleeve ensures a large-area introduction and uniform distribution of the axial and radial pretensioning forces into the second and/or first pressure plate, which are generated by the tensioning of the plug-in part within the securing slot of the centering mandrel. The possibility of adapting the outer cross-section of the centering sleeve in the second sleeve section, i.e., the collar or its flange, makes it possible to advantageously create, on the one hand, a maximized inner flange area for the full-surface contact of the centering sleeve with the mounting side of the second and/or first pressure plate and, on the other hand, the largest possible outer flange area for the full-surface contact of a second contact area of the plug-in part.

Furthermore, provision can be made that the flange of the centering sleeve is provided with one or more fastening devices for non-rotational fastening to the first and/or second pressure plate.

To secure the connection device, a plug-in part is used, which is inserted in particular into a securing slot located in the conical centering pin of the connection bolt, preferably from above. The plug-in part can be designed in different lengths, so that its contact area can be adapted to the outer flange area of the second sleeve section of the centering sleeve.

Another advantage of the connection device is that it is adjustable. The adjustability is achieved in particular by means of the plug-in part, the position of which can be changed within limits.

After the connection bolt has been pushed through the at least one second through-opening in the second pressure plate and after the centering sleeve has been inserted into the free space forming between the second lateral surface of the connection bolt and the wall of the at least one second through-opening, the plug-in part is inserted into the continuous securing slot located in the conical region of the centering pin of the connection bolt.

The plug-in part is solid and can have different outer contours in its respective contact areas. The outer contour of a first contact area forms the head-side termination and absorbs the clamping forces preferably introduced by hammer blows during assembly of the connection device. The outer contour of a second contact area lies directly against the outer flange area of the centering sleeve in the assembled state of the connection device and introduces axial and radial clamping forces into this by means of a positive fit. The outer contour of a third contact area can have a rounded shape. By means of the rounding of the outer contour, a full-surface contact of the third contact area of the plug-in part against the outer wall of the securing slot of the centering mandrel can be achieved, thereby creating maximum tightening of the plug-in part within the centering mandrel.

This third contact area can form an angle with respect to the second contact area and, within the securing slot of the connection bolt, causes the plug-in part to be forced against the inner and outer walls of the securing slot, respectively.

When mounted, the plug-in part can be secured against upward movement by means of a securing plug, which can be designed in the form of a spring cotter (standard part). Depending on the insertion depth of the plug-in part within the securing slot, the securing plug can be inserted into at least one securing bore provided in the lower leg area of the plug-in part in order to secure the plug-in part in its respective position within the securing slot. In this way, a permanent fixing of the plug-in part and thus the securing of sufficient tensioning forces of the plug-in part, on the one hand within the securing slot of the connection bolt and on the other hand towards the outer contact area of the centering sleeve and thus towards the mounting side of the first and/or second pressure plate, can be permanently guaranteed.

Depending on the wear of the bottom chord connection, which depends on the duration of use of the crane and the associated deformations of the individual cantilever segments, the strength of the bottom chord connection can be permanently maintained at a high level by slipping of the plug-in part due to its own weight or by mechanical readjustment of the plug-in part, in particular by means of hammer blows.

In the case of the lower chord connection, the connection device can be modelled on a fixed bearing. According to a further aspect, it has been shown to be advantageous, in a preferred embodiment, to relieve the load on the connection device according to the invention, in its embodiment as a fixed bearing, by means of a further cantilever connection. A further cantilever connection can be formed by an additionally introduced fixing device, which can be designed as a floating bearing complementary to the fixed bearing of the connection device. In this case, the fixed bearing can be located outside the end face of the lower chords. The floating bearing can be arranged on or within the end face of the lower chords. The contact areas which are formed directly in the joints above the ends of the lower chord tubes, transverse to the longitudinal axis of the cantilever, are to be understood as front end terminations of the lower chords. Through the interaction of the fixed bearing and the loose bearing, the lower chords of two cantilever segments to be connected, and in particular the joints above the ends of the lower chord tubes, are on the one hand fixed to each other and to each other in the correct position and on the other hand permanently and detachably connected to each other by means of adjustable connection forces.

A movable trolley can be arranged along the lower cantilever. Loads suspended from the trolley can exert a maximum bending moment on the pressure plates in the end face area of the lower chords (chords) during crane operation when the trolley is travelling over the areas of the cantilever connections, i.e., the cantilever joints. This can lead to permanent, local deformations of the frontal areas of the cantilever joints in such a way that at least one step can be formed between the oppositely positioned and adjacent cantilever joints. As the lower chords usually have trolley running surfaces, such steps can lead to mechanical impacts during trolley travel under load.

According to a further aspect, the above lower chord connection is provided with the connection device, the lower chord connection interconnecting two respective lower chords of the cantilever segments, i.e., a lower chord of the first cantilever segment and a corresponding lower chord of the second cantilever segment, wherein a fixing device is provided at the end face of the two respective lower chords to secure the lower chords against displacement transversely to their axial direction.

It has therefore proved to be advantageous if an additional fixing device introduced in the highly loaded lower chord area of the pressure plate can support the centering effect of the connection device. This local support caused by the fixing device leads to an additional relief of the connection device and to a permanent and low-wear fixing of the lower chords to each other and to each other in the area of the joints, which are located in the immediate area above the front ends of the lower chord tubes. In particular, the fixing device can be centered in the surfaces of the front-end terminations, i.e., the joints of the lower chords. Further arrangements of the fixing device within the lower chord connection are conceivable, for example in an area above or below or laterally to the structural center of the respective lower chord.

Furthermore, the fixing device can comprise:
at least one screw mandrel with a first fastening section for fastening to the first pressure plate and with a second fastening section for fastening to the second pressure plate,
wherein the second fastening portion has a lateral surface portion for fastening the screw mandrel to the second pressure plate,
wherein a bushing is provided for inserting into a through opening in the second pressure plate,
wherein the bushing has an inner wall to receive the mantle surface portion of the second fastening portion in the through opening.

Furthermore, the first fastening section can be provided with a threaded section for fastening the screw mandrel to a threaded hole in the first pressure plate.

Provision can be made such that the lateral surface section of the second fastening section is received in the through-opening in a form-fitting and friction-fitting manner.

Thus, in addition to the connection device according to the invention, at least one further fixing device can be provided, comprising:
at least one screw mandrel with a first fastening section for fastening to a first pressure plate of a first cantilever segment and with a second fastening section for fastening to a second pressure plate of a second cantilever segment,
   wherein the first fastening portion is provided with a threaded portion for fastening the screw mandrel to a threaded hole in the first pressure plate,
   wherein the second fastening portion has a lateral surface portion for fastening the screw mandrel to the second pressure plate,
at least one socket for inserting into a corresponding through opening, wherein the through opening is located in the second pressure plate,
   wherein the bushing has an inner wall for receiving the lateral surface portion of the second fastening portion in a form-locking and friction-locking manner.

A further advantage of the novel lower chord connection is thus given in particular by the introduction of an additional fixing device. The elements of the fixing device mounted on the cantilever segments to be connected complement each other. For this purpose, a first cantilever segment has a first pressure plate in the foot area of its front end. This first pressure plate accommodates the connection device described above as well as the fixing connection by means of which a second pressure plate present in a second cantilever segment to be connected is connected. The first and second pressure plates, which are connected by the connection device and the fixing device, are predominantly in positive contact with each other over their entire surface, and any frictional contact between the first and second pressure plates can be neglected when determining the connection forces generated between the cantilever segments by means of the connection device and the fixing device.

Furthermore, it is advantageous if the at least one fixing device comprises a preferably one-piece and rotationally symmetrically designed screw mandrel with a first and a second fastening section, a threaded bore located in a first pressure plate and receiving the first fastening section, a further through-opening located in the second pressure plate and receiving the second fastening section, and a bushing arranged between the second fastening section and the further through-opening. Provision can be made that the first fastening portion of the fixing device has a threaded portion which directly adjoins a preferably cylindrically formed lateral surface portion of the second fastening portion of the fixing device. In particular, the first fixing section can be fixed by means of the threaded section by screwing it into a threaded hole located in the first pressure plate. In the second fastening section of the fixing device, an outer surface section as well as a head region can be formed, wherein the outer surface section can in particular have a cylindrical shape and the head region can in particular have a hexagonal profile. It is further conceivable that the lateral surface section as well as the head region can have a polygonal shape, for example a triangular, square or pentagonal shape. A chamfer can be formed between the head region and the lateral surface portion of the second fastening portion. The chamfer can facilitate the insertion of the lateral surface section of the second fastening section into a complementary geometrically designed bushing.

The fixing device can comprise a bushing which can be arranged within a corresponding through-opening in a second pressure plate. This through-opening can in particular be designed as a bore, wherein this bore can in particular have a round profile. The bushing can in particular be designed as a replaceable bushing, and can in particular have the shape of a tube which does not necessarily have to be round and has an inner wall and an outer wall with an intermediate surface which does not necessarily have to be designed as an annular surface. At a first end of the bushing, a chamfer can be arranged between the surface and the inner wall, which serves as an insertion aid complementary to the chamfer of the screw mandrel and facilitates the threading of the lateral surface of the screw mandrel during assembly. A second end of the bushing can be arranged directly in front of a stiffening plate and find a spatial stop there. By means of this spatial stop, the bushing is secured in its longitudinal direction against migration into the rear area of the lower chord. The stiffening plate serves in the manner of a bulkhead plate on the one hand to stiffen the lower chord in the indirect area of the connection between two lower chords and on the other hand to seal the lower chord against penetrating water and the associated corrosion of the rear area of the lower chord.

In order to accommodate several centering trunnions and several screw pins in the same direction according to a preferred embodiment, it has proved advantageous if the first pressure plate has several first through-holes and the second pressure plate has several second through-holes corresponding to the first through-holes as well as a further through-holes. The same orientation of the mounted connection bolts and screw mandrels (preferably parallel with respect to their longitudinal directions) is then understood to mean that the connection bolts and screw mandrels located in and on the pressure plates point in the same direction.

It can thus be provided that at least one further screw mandrel is provided with the first fastening portion for fastening to the second pressure plate of the second cantilever segment and with the second fastening portion for fastening to the first pressure plate of the first cantilever segment, wherein the first fastening portion of the further screw mandrel is provided in particular with a metric thread of normal pitch for fastening to the first pressure plate, wherein the second fastening portion of the further screw mandrel is provided with a lateral surface portion for releasable fastening in a further through opening in the second pressure plate, and a bushing is provided for inserting into the further through opening in the second pressure plate, said bushing having an inner cross-section with a corresponding shape for receiving the lateral surface portion of the second fastening portion of the screw mandrel in a form-locking and friction-locking manner.

### BRIEF DESCRIPTION OF THE DRAWINGS

Further details of the invention are explained in more detail with reference to an exemplary embodiment shown in the accompanying drawings. Identical multiple references to a component in one and the same figurative representation include both the singular and plural of the respective element depicted, wherein:

FIGS. 1a, 1b are perspective overview illustrations of end-face embodiments of the tower crane cantilever segment in the non-assembled state;

FIGS. 2a, 2b, 2c are perspective overview illustrations of the foot area of two cantilever segments connected by means of the lower chord connection according to one embodiment;

FIG. 2d is a perspective overview of the foot area of two cantilever segments connected by means of the lower chord connection according to a further embodiment;

FIGS. 3a, 3b are perspective views of pressure plates according to an embodiment, wherein the pressure plates are detached from the truss or lattice structure of the cantilever segment when seen from an individual perspective;

FIG. 3c is a side view and a perspective view of a pressure plate according to a further embodiment, wherein the pressure plate is detached from the truss or lattice structure of the cantilever segment when seen from an individual perspective;

FIG. 4 is a perspective overview of elements of the bottom flange connection (exploded view), as well as two pressure plates to be connected to each other;

FIG. 5a is a perspective view of the elements of the bottom flange connection according to a preferred embodiment as well as the pressure plates of a preferred embodiment connected by means of the bottom flange connection;

FIG. 5b is a perspective view of the elements of the bottom flange connection according to a further embodiment as well as the pressure plates of a further embodiment connected by means of the bottom flange connection;

FIG. 6 is a sectional view of the assembled elements of the lower chord connection as well as the lower chords and the pressure plates;

FIG. 7 is a lateral and perspective view of the connection bolt;

FIG. 8 is a side view and perspective view of the centering sleeve; and

FIG. 9 is a perspective view of the plug-in part;

FIGS. 10a, 10b are perspective overview representations of the end faces of preferred embodiments of the tower crane cantilever segment in the non-assembled state;

FIG. 11a is a sectional view of the foot area of two cantilever segments connected by means of the connection device and the fixing device according to a preferred embodiment;

FIG. 11b is a cross-sectional view of the assembled elements of the fixing device as well as the connection device according to a preferred embodiment of the bottom chord connection as well as the bottom chords and the pressure plates;

FIG. 12 is a cross-sectional view of the assembled elements of the fixing device according to a preferred embodiment of the bottom chord connection, as well as the bottom chords and the pressure plates;

FIGS. 13a, 13b are perspective views of pressure plates according to a preferred embodiment of the lower chord connection, wherein the pressure plates are detached from the truss or lattice structure of the cantilever segment in individual when seen from an individual perspective.

### EXEMPLARY EMBODIMENTS

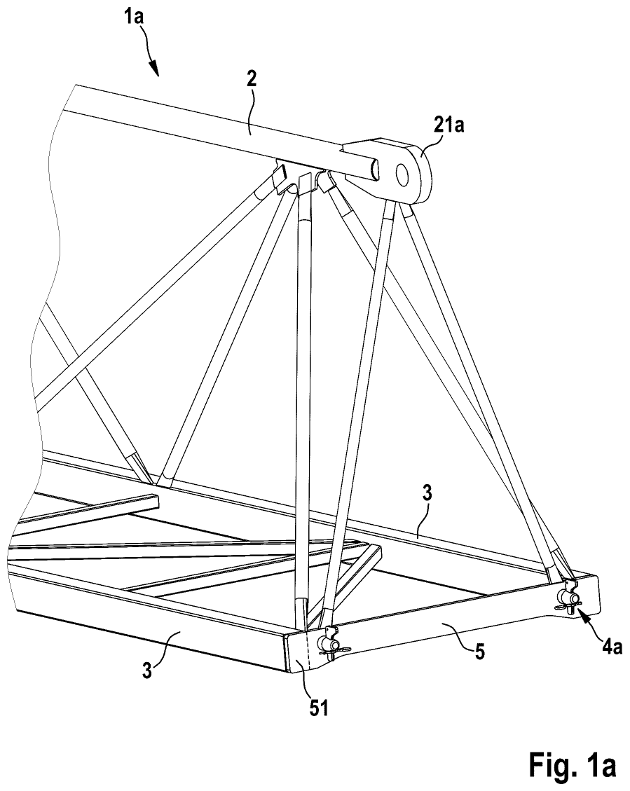

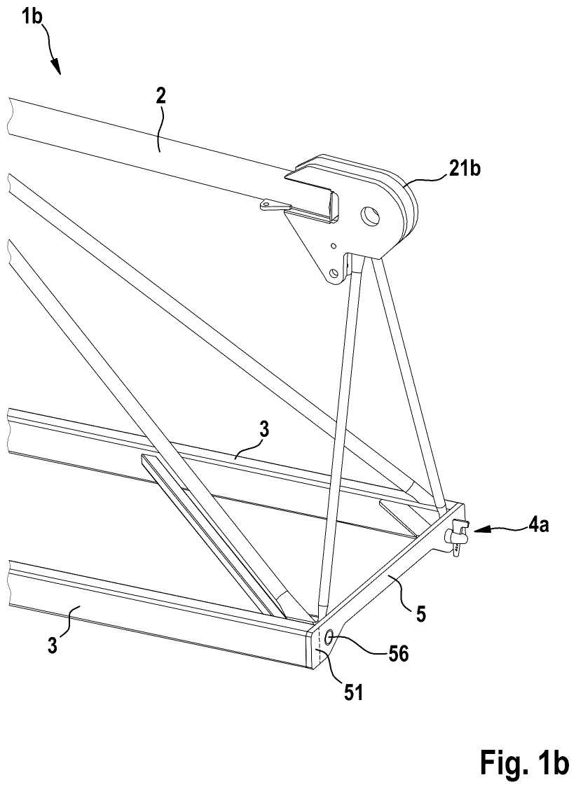

FIGS. 1a, 1b show connection areas of two embodiments of a cantilever segment comprising a top chord 2, a terminating top chord connection 21a and an end face of a pressure plate 5 connecting and terminating the bottom chords 3. The shown elements of the upper belt connection 21a of a first cantilever segment 1 are connected to a complementary element of an upper belt connection 21b of a second cantilever segment 1b (not shown). At least one lower chord connection with a connection device 4a of a first cantilever segment la is attached to the pressure plate 5 for transport purposes.

The elements of the at least one lower chord connection are located in the foot area of the end face of the cantilever segment la and outside an end face 51 of the lower chords 3.

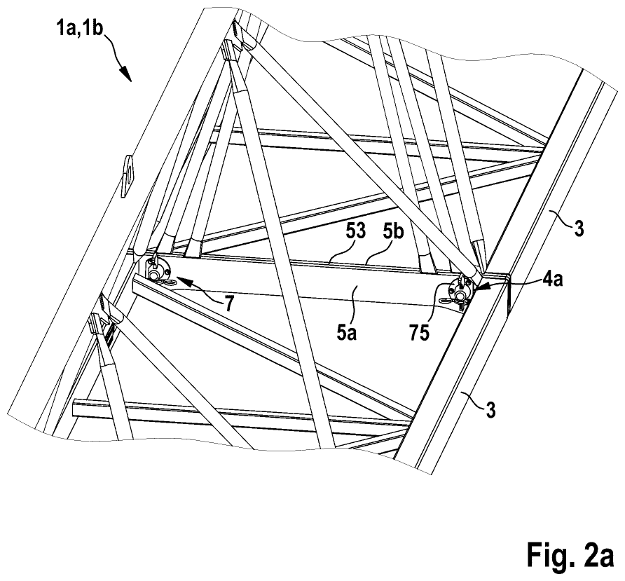

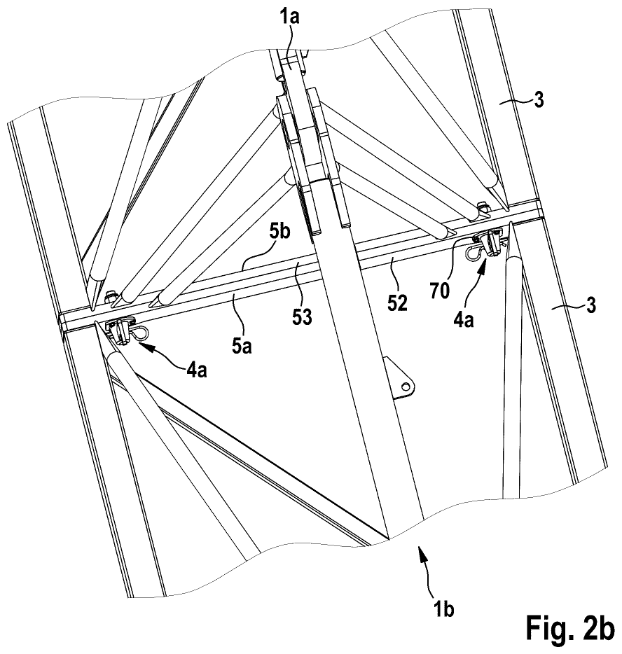

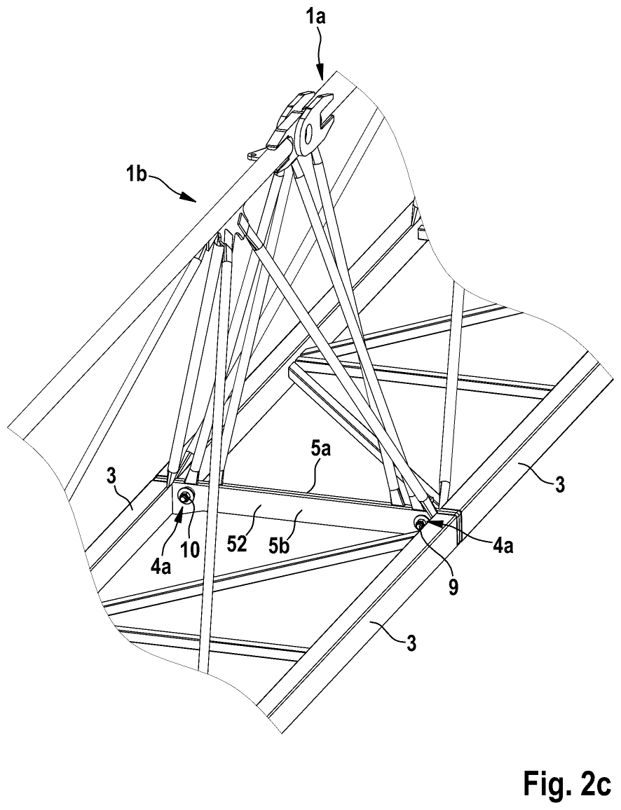

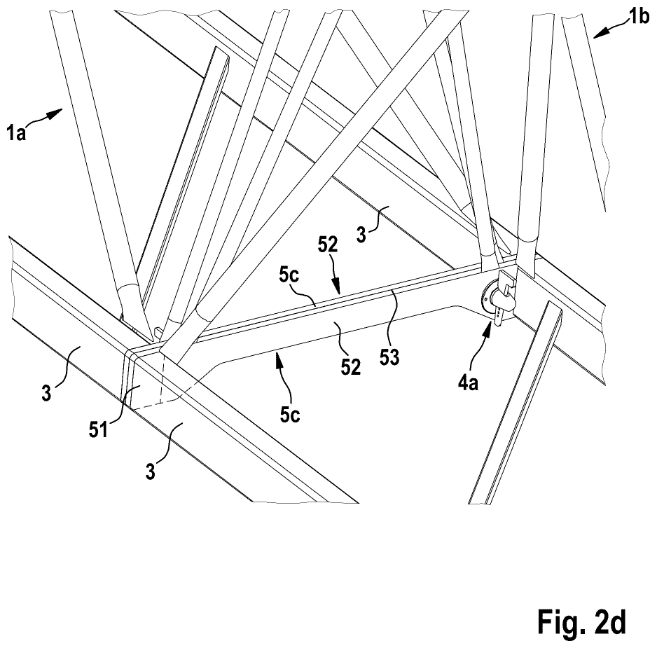

FIGS. 2a, 2b, 2c show the foot area of two cantilever segments 1a, 1b connected to each other by means of the bottom chord connection as well as the integration of these foot areas into the truss or lattice structure of the respective cantilever segment 1a, 1b in different spatial perspectives. The pressure plates 5a, 5b lie with their end faces 53 directly against each other and close flush with each other at the end face terminations 51 (not visible in this illustration in the assembled state) of the bottom chords 3. The at least one lower chord connection of this preferred embodiment is mounted on the pressure plates 5a or 5b, and is located in the spatial vicinity of the lower chord 3 in the foot area of the cantilever segment la, 1b. In FIGS. 2a and 2b the heads of locking screws (standard screws) are shown, which are located on the outer flange area 75 of the flange 70 of the centering sleeve 7 in holes 78 (not shown), and by means of which the centering sleeve 7 is screwed into standard threads (not shown) located on the mounting side 52 of the pressure plate 5a, thus securing it against loss and/or rotation. FIG. 2c shows the crown nut 10 and the washer 9 as elements of the bottom flange connection 4, which are located on the mounting side 52 of the pressure plate 5b.

FIG. 2d shows the foot area of two cantilever segments 1a, 1b connected to each other by means of the bottom chord connection as well as the integration of these foot areas into the truss or lattice structure of the respective cantilever segment 1a, 1b in a spatial perspective. The pressure plates 5c lie with their end faces 53 directly against each other and close flush with each other at the end face terminations 51 (shown dashed) of the bottom chords 3. The elements of the at least one lower chord connection of this further embodiment are each mounted on the pressure plates 5c on the mounting side 52 and are located in spatial proximity to the lower chord 3 in the foot area of the cantilever segment 1a, 1b.

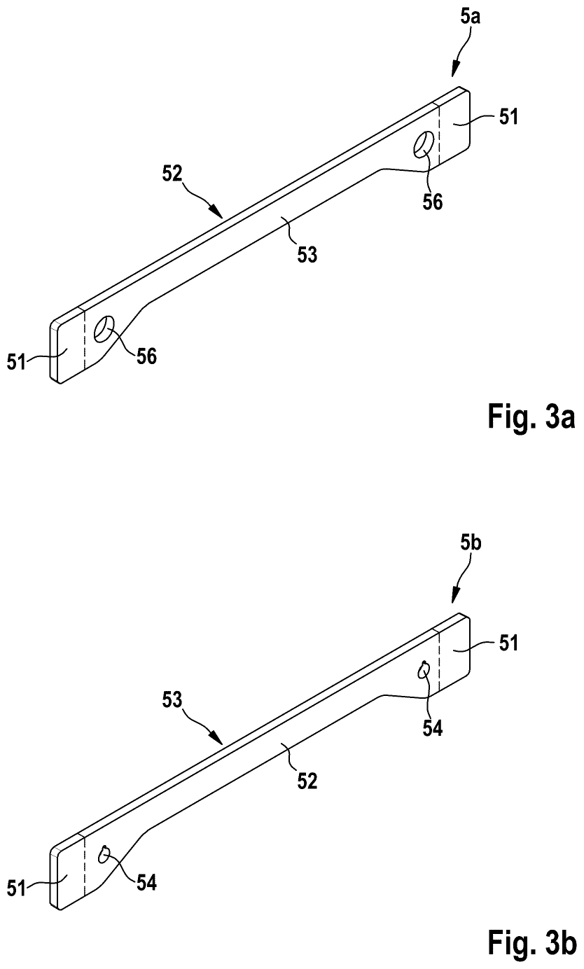

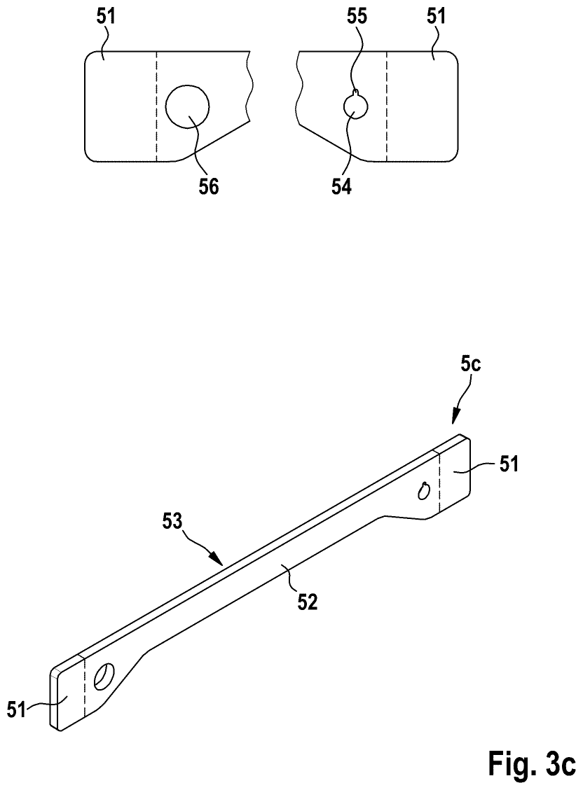

FIG. 3a shows a pressure plate 5a detached from the truss or lattice structure of the respective cantilever segment 1b, 1b according to the preferred embodiment. The second through openings 56 in the pressure plate 5a receive centering sleeves 7 (not shown) on their walls.

FIG. 3b shows a pressure plate 5b detached from the truss or lattice structure of the respective cantilever segment la, 1b according to the preferred embodiment. The first through-holes 54 in the pressure plate 5b are each widened in their upper area by a recess 55. The walls of the first through-holes 54 in the pressure plate 5b each receive the lateral surfaces 63 (second lateral surface section) of the connection bolts 6 (not shown). The mounting side 52 of the pressure plate 5b is a contact area for the locking washer 9 (not shown).

FIG. 3c shows a pressure plate 5c detached from the truss or lattice structure of the respective cantilever segment 1a, 1b according to a further embodiment. A first through-opening 54 located in the pressure plate 5c is widened in its upper area by a recess 55. The wall of the first through-opening 54 in the pressure plate 5c receives the lateral surface 63 (second lateral surface section) of the connection bolt 6 (not shown). A second opening 56 in the pressure plate 5c receives the centering sleeve 7 (not shown) on its wall. The mounting side 52 of the pressure plate 5c is a contact area for the locking washer 9 (not shown).

In FIGS. 3a, 3b and 3c, the front-end portions 51 represent the outer end portions of the pressure plate 5a, 5b and 5c, which are located in the front-end portion of the lower chord 3 (not shown).

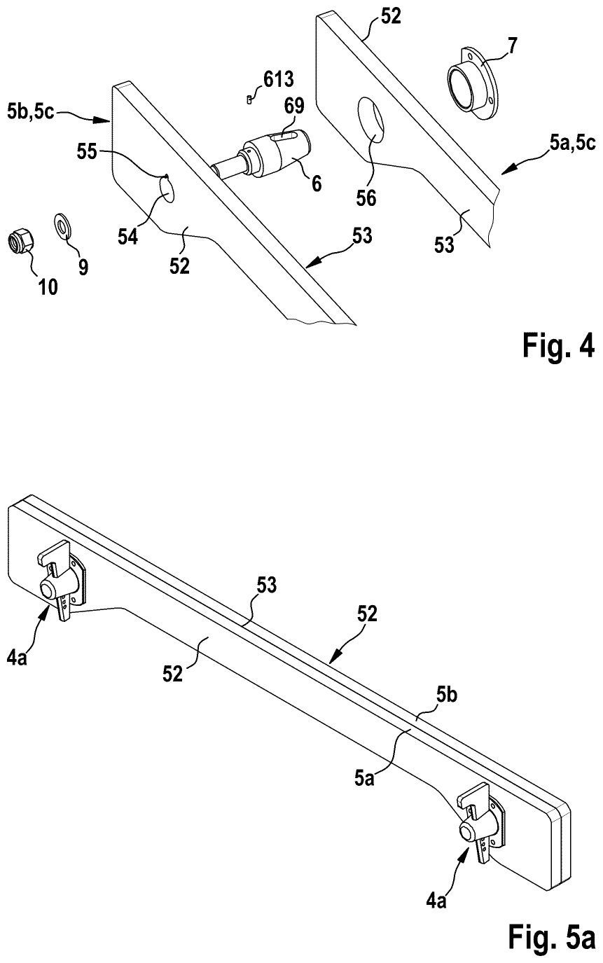

FIG. 4 shows elements of the lower chord connection 4a detached from the truss or lattice structure of the respective cantilever segment 1a, 1b in the non-assembled state (exploded view) outside of their engagement in the respective pressure plate 5a, 5b or 5c. The first fastening part of the connection bolt 6, which can be inserted into the first through-opening 54 and the slot-like extension 55 on the front side 53 of the first pressure plate 5b or 5c, is screwed during subsequent assembly on the assembly side 52 of the pressure plate 5b or 5c by means of the screw thread section 64 (not shown) as well as the washer 9 and the crown nut 10. The second fastening part of the connection bolt 6, which can be inserted into the second through-opening 56 of the second pressure plate 5a or 5c, is secured during subsequent assembly on the assembly side 52 of the second pressure plate 5a or 5c by means of the centering sleeve 7 inserted into the second through-opening 56 on the assembly side 52, as well as the plug-in part 8 (not shown) located in the securing slot 69 in the later course of assembly and a spring plug (not shown) located in a securing bore 84 (not shown) of the plug-in part 8 (not shown).

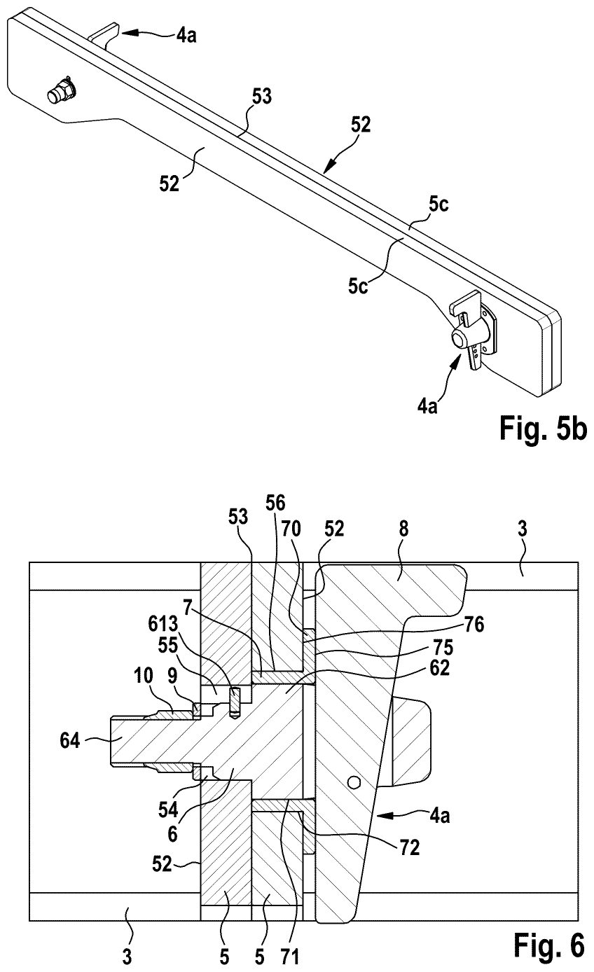

FIG. 5a shows the preferred embodiment detached from the truss or lattice structure of the respective cantilever segment 1a, 1b with connection devices 4a of the bottom chord connection as well as the different pressure plates 5a and 5b in the assembled state. It can be seen that the connection devices 4a are mounted in the same direction on the respective pressure plate 5a and 5b, and elements of the lower belt connections 4a protrude from the respective mounting side 52 of the pressure plate 5a. The end faces 53 (not shown) of the pressure plates 5a and 5b lie against each other over their entire surface, wherein the connection of the pressure plates 5a and 5b achieves a high degree of tightness by means of a form and friction fit between the end faces 53.

FIG. 5b shows a further embodiment with bottom chord connections detached from the truss or lattice structure of the respective cantilever segment 1a, 1b as well as two identical pressure plates 5c in the assembled state. It can be seen that the lower chord connections are mounted alternately on the respective pressure plate 5c and elements of the lower chord connections protrude from the respective mounting side 52 of the pressure plates 5a and 5c. The end faces 53 (not shown) of the pressure plates 5c lie against each other over their entire surface, wherein the connection of the pressure plates 5c achieves a high degree of tightness by means of a form and friction fit between the end faces 53.

FIG. 6 shows a section through the connection device 4a of the lower chord connection in its installed position, within the pressure plates 5 (in embodiments 5a, 5b or 5c) connected to each other by it. The end faces 53 of the pressure plates 5 (in embodiments 5a, 5b or 5c) lie against each other over their entire surface. The connection bolt 6 is screwed to the first pressure plate 5b or 5c by means of its screw thread section 64 as well as the fitted washer 9 and the crown nut 10 on the mounting side 52. To secure the position during the screwing of the connection bolt 6 to the first pressure plate 5b or 5c, a centering pin 613 is located in the slot-shaped extension 55 of the first through-opening 54.

In the radial direction, the centering sleeve 7 receives the outer surface 62 (first outer surface section) of the connection bolt 6 on the inner wall 71 of its first sleeve section. In the axial direction of the centering sleeve 7, the plug-in part 8 rests against the outer flange area 75 of the second sleeve section.

The centering sleeve 7 transmits the axial pre-tensioning forces generated by the connection bolt 6 and the plug-in part 8 located in the securing slot 69 by means of the flange 70 formed in its second sleeve section via its outer flange area 75 and its inner flange area 76 to the mounting side 52 of the second pressure plate 5 (in embodiments 5a or 5c).

In addition, the centering sleeve 7 transmits the radial pre-tensioning forces introduced by the connection bolt 6 via its lateral surface 62 (first lateral surface section) by means of the inner wall 71 and the outer wall 72 of its first sleeve section to the wall of the second through-opening 56 of the second pressure plate 5 (in embodiments 5a or 5c).

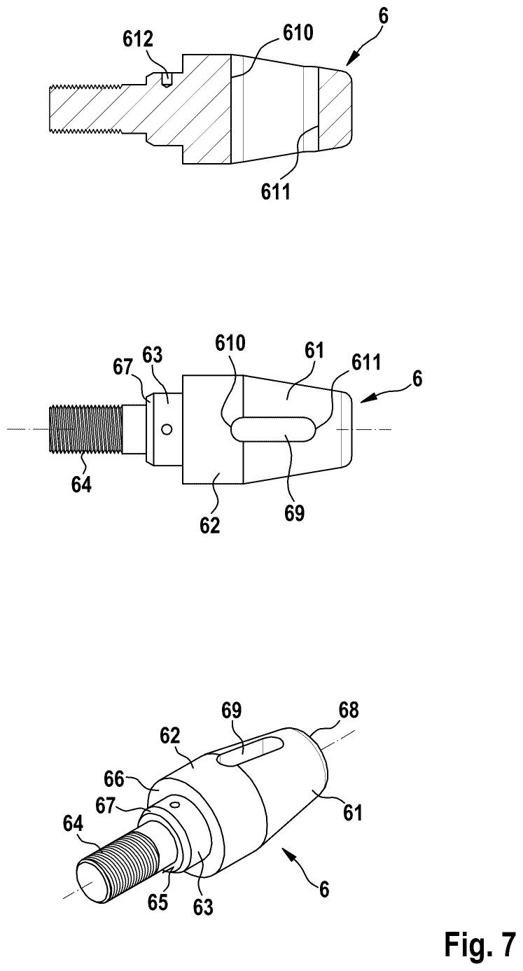

FIG. 7 shows the details of the connection bolt 6. In particular, the lateral surface 63 (second lateral surface section) and the lateral surface 62 (first lateral surface section) as well as the first contact area 65 and the second contact area 66 represent the surfaces via which the axial and radial pre-tensioning forces of the lower chord connection 4 generated by the connection bolt 6 are introduced onto the end face 53 (not shown) of the pressure plate 5a, 5b or 5c (not shown) and the inner wall 71 (not shown) of the centering sleeve 7 (not shown).

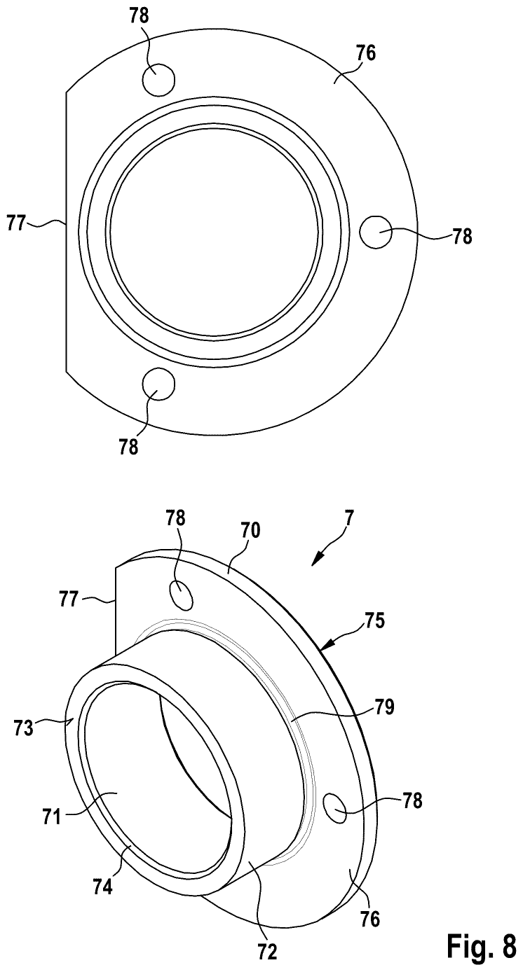

FIG. 8 shows details of the centering sleeve 7. A tubular first sleeve section of the centering sleeve is bounded by an inner wall 71 and an outer wall 72 and by a surface 73 between the inner wall 71 and the outer wall 72 and ends in an undercut 79. A second sleeve section of the centering sleeve starts from the undercut 79 and is a circumferential flange 70 in the form of a collar. The circumferential flange 70 has an outer flange area 75 and an inner flange area 76, as well as a lateral termination 77. The holes 78 located in the flange 70 receive standard screws (not shown) for securing the centering sleeve 7 to the mounting side 52 of the pressure plate 5a or 5c. These locking screws (not shown) are screwed to the pressure plate 5a or 5c on the mounting side 52 by means of standard threads located in the pressure plate 5a or 5c (not shown) and serve to secure the centering sleeve 7 against loss and/or rotation.

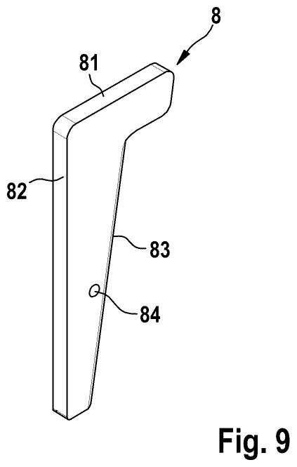

FIG. 9 shows the details of the plug-in part 8. The plug-in part 8 lies in the assembled or plugged-in position (not shown) within the securing slot 69 (not shown), which is located in the lateral surface 61 (third lateral surface section, not shown) of the conical centering pin of the connection bolt 6 (not shown). The outer contour 82 of the plug-in part 8 represents on the one hand the contact area with the inwardly directed wall 610 (not shown) of the securing slot 69 (not shown) and on the other hand with the outer flange area 75 (not shown) of the centering sleeve 7 (not shown). The outer contour 83 represents the contact area of the plug-in part 8 to the outwardly directed wall 611 (not shown) of the securing slot 69 (not shown) of the connection bolt 6 (not shown). The outer contour 81 serves as a receiving surface for hammer blows, which are entered for fixing and, if necessary, readjusting the plug-in part 8 within the securing slot 69 (not shown).

The at least one securing bore 84 located in the lower region of the plug-in part 8 can receive a spring cotter (standard part, not shown) for securing the plug-in part 8. The at least one securing bore 84 is located in a space below the securing slot 69 (not shown) of the connection bolt 6 (not shown) when the plug-in part 8 is in the plugged-in and set or readjusted position.

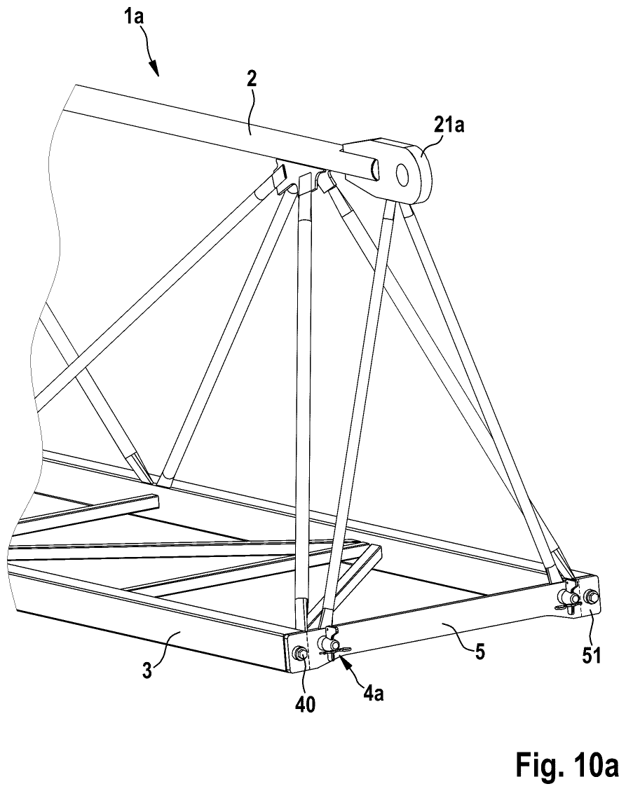

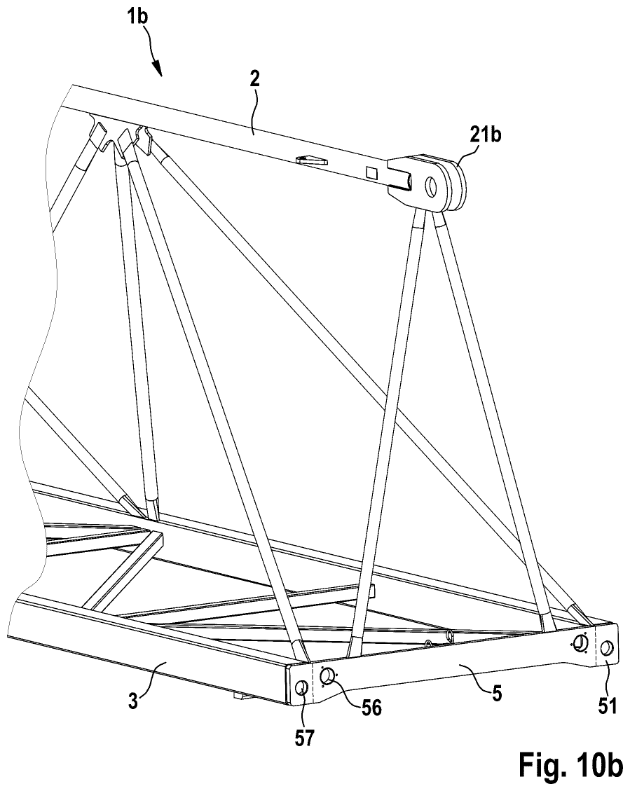

FIGS. 10a and 10b show the connection areas of two cantilever segments 1a, 1b according to a preferred embodiment, each comprising a top chord 2, terminating top chord connections 21a, 21b and the end faces 53 of a pressure plate 5 connecting and terminating the bottom chords 3. The shown elements of a top chord connection 21a of a first cantilever segment la is connected to a complementary element of a top chord connection 21b of a second cantilever segment 1b. Two fixing devices 4b and two connection devices 4a of a first cantilever segment la are fixed to the pressure plate 5. A respective screw pin 40 is located for the fixing connections 4b in the foot area of the cantilever segment la in the end-face termination 51 for each of the lower chords 3. The at least one through-opening 56 is located within the pressure plate 5 in the foot area of the cantilever segment 1b and between the end-face terminations 51.

At least one through opening 57 for receiving the screw mandrel 40 is located in the pressure plate 5 in the foot area of the cantilever segment 1b and within the end face termination area 51.

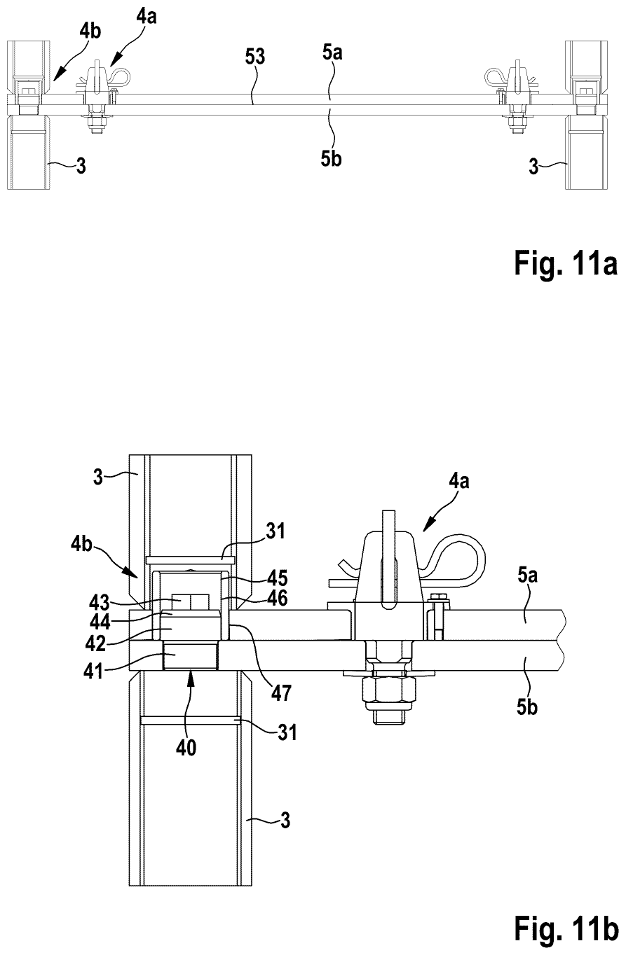

FIG. 11a shows the foot area of two cantilever segments 1a, 1b connected to each other by means of the lower chord connections 4a and 4b according to a preferred embodiment in a sectional view (top view). The pressure plates 5a,5b lie with their end faces 53 directly against each other. The connection devices 4a and the fixing devices 4b are mounted on the pressure plates 5a and 5b and are located in the spatial vicinity of the lower chords 3 in the foot area of the cantilever segment 1a,1b.

FIG. 11b shows a section of the foot area of two cantilever segments 1a, 1b connected to each other by means of the connection device 4a and the fixing device 4b according to a preferred embodiment in a sectional view (top view). The connection device 4a and the fixing device 4b are mounted on the pressure plates 5a and 5b and are located in the spatial vicinity of the lower belt 3 in the foot area of the cantilever segment 1a, 1b.

The fixing device 4b comprises a bushing 45 which is arranged in the corresponding through-opening 57 within the pressure plate 5a, the bushing 45 and the through-opening 57 preferably having no play relative to one another. This ensures that the bushing 45 is, on the one hand, firmly mounted within the through-opening 57 and, on the other hand, can preferably be pulled out and replaced by means of a bushing pulling tool which is applied to the inner wall 46 of the bushing 45.

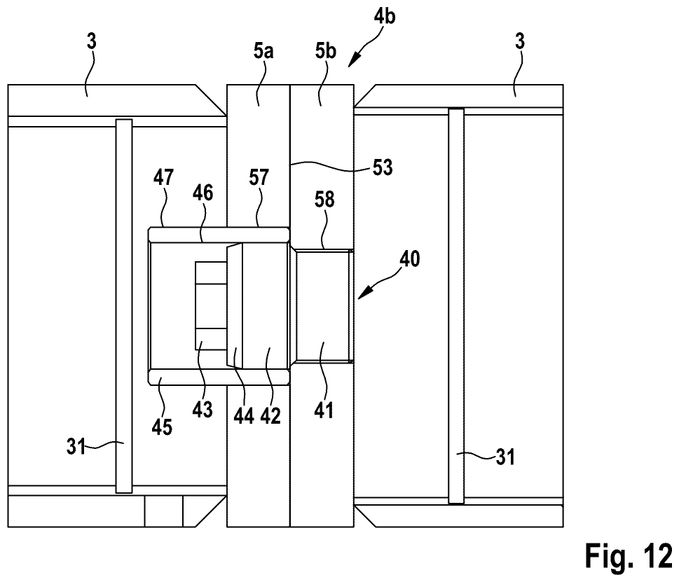

FIG. 12 shows a section of two cantilever segments 1a, 1b connected to each other by means of the fixing device 4b according to a preferred embodiment in a sectional view (side view). The screw mandrel 40 has a threaded section 41 in a first fixing section. The threaded section 41 is screwed into a threaded hole 58, the threaded hole 58 being arranged in the end-face termination region 51 of the pressure plate 5b. In a second fastening section, the screw mandrel 40 has a lateral surface section 42 which directly adjoins the threaded section 41. In the assembled state, the lateral surface section 42 of the screw mandrel 40 is located directly above the end face 53 of the pressure plate 5b and is in positive and frictional contact with the inner wall 46 of the bushing 45. A chamfer 44 can be located between the head 43 of the screw mandrel 40 and the lateral surface section 42 of the screw mandrel 40 and facilitate the threading of the screw mandrel 40 into the bushing 45. In particular, the head 43 can be hexagonal in shape to receive a tool, which can be in the form of an open-end spanner.

The outer wall 47 of the bushing 45 lies directly against the wall of the through opening 57 within the pressure plate 5a. In the assembled state, the bushing 45 lies directly in front of the stiffening plate 31, which delimits the rear end area within the lower chord 3. The bushing 45 is not fixed in the rear end area either to the through opening 57 or to the stiffening plate 31, but its outer wall 47 has a slight oversize compared to the diameter of the through opening 57 and is detachably mounted within the rear end area by means of a press fit.

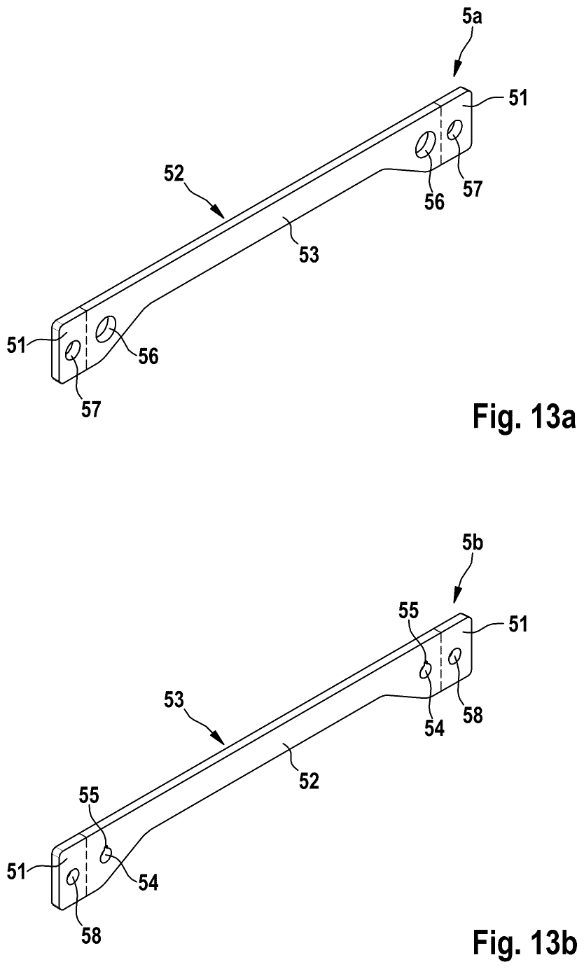

FIG. 13a shows a pressure plate 5a detached from the truss or lattice structure of the respective cantilever segment 1b, 1b, according to a preferred embodiment. The through openings 56 in the pressure plate 5a receive centering sleeves 7 (not shown) on their walls. The through-holes 57 in the pressure plate 5a receive bushes 45 (not shown) on their walls.

FIG. 13b shows a pressure plate 5b detached from the truss or lattice structure of the respective cantilever segment 1a, 1b according to a preferred embodiment. The through openings 54 in the pressure plate 5b are each widened in their upper area by a recess 55. The walls of the through-openings 54 in the pressure plate 5b each receive the lateral surfaces 63 (second lateral surface section) of the connection bolts 6 (not shown). The threaded holes 58 in the pressure plate 5b are provided with metric internal threads (not shown), which receive the metric external threads of the screw mandrels 40 (not shown) located in the threaded sections 41.

### LIST OF REFERENCE SIGNS

1a, 1b cantilever segment
2 upper belt
21a,21b upper belt connection
3 lower belt
31 stiffening plate
4a connection device
4b fixing device
40 screw mandrel
41 thread section of the screw mandrel
42 sheathing surface section of the screw mandrel
43 head area
44 chamfer
45 bushing
46 inner wall of bushing 45
47 outer wall of bushing 45
5 pressure plate (pressure plate 5a,5b,5c)
51 front end area above the lower chord ends
52 mounting side of the pressure plate 5a,5b,5c
53 front side of the pressure plate 5a,5b,5c
54 first through opening within pressure plate 5b,5c
55 slot-shaped extension of first through-opening 54
56 second through opening within pressure plate 5a,5c
57 through opening within pressure plate 5a,5c
58 threaded hole within pressure plate 5b
6 connection bolt
61 sheath surface (cone) of centering pin of connection bolt (third sheath surface section)
62 sheath surface (cylinder) of connection bolt (second sheath surface section)
63 sheath surface (cylinder) of connection bolt (first sheath surface section)
64 screw thread section
65 first contact area of connection bolt
66 second contact area of connection bolt
67 chamfer (between sheath section 1 and sheath section 2)
68 chamfer (between sheath section 1 and sheath section 2)
69 securing slot in centering pin of connection bolt (fourth section)
610 inner wall of securing slot (contact area of outer contour 1 of plug-in part 8)
611 outer wall of the securing slot (contact area of outer contour 2 of plug-in part 8)
612 bore in lateral surface 63 of connection bolt
613 centering pin for centering connection bolt in slot-shaped extension 55
7 centering sleeve
70 flange (second sleeve section of centering sleeve, collar)
71 inner wall of first sleeve section of centering sleeve
72 outer wall of first sleeve section of centering sleeve
73 area between the inner and outer wall of first sleeve section of centering sleeve
74 chamfer between area and inner wall of first sleeve section of centering sleeve
75 outer flange area of flange 70, outer contact area of second sleeve section of centering sleeve (contact area for second contact area of plug-in part)
76 inner flange area of flange 70, inner contact area of second sleeve section of centering sleeve (contact area for mounting side of pressure plate)
77 lateral end of centering sleeve
78 bores for accommodating locking screws
79 clearance between first and second sleeve section of centering sleeve
8 plug-in part
81 outer contour of first contact area of plug-in part
82 outer contour of second contact area of plug-in part
83 outer contour of third contact area of plug-in part
84 securing bore for receiving a spring plug (standard part)
9 disc (standard part)
10 crown nut (standard part)

1. A lower chord connection with a connection device for connecting cantilever segments of a cantilever of a tower crane, comprising:
at least one connection bolt with a first fastening part, for fastening to a first pressure plate of a first cantilever segment and with a second fastening part, for fastening to a second pressure plate of a second cantilever segment,
wherein the first fastening part is provided with a releasable, twist-proof connecting means for fastening to the first pressure plate,
wherein the second fastening part, is provided with a centering mandrel for fastening to the second pressure plate, which has a radial securing slot for receiving a plug-in part; and
a centering sleeve for inserting into a corresponding through-opening in the second pressure plate which has an internal cross-section for positively receiving the second fastening part.

2. The lower chord connection with a connection device according to claim 1, wherein the centering pin has a section tapering towards the second fastening part, and adjoins a first cylindrical lateral surface section which, in an assembled state, can be received in the centering sleeve, in a form-fitting manner.

3. The lower chord connection comprising a connection device according to claim 1, wherein the centering sleeve has a wholly or partially circumferential flange with flange areas which is provided at an axial end of the centering sleeve and is arranged in an assembled state in the direction of the second fastening part.

4. The lower chord connection comprising a connection device according to claim 3, wherein the flange is provided with flange areas and bores by means of one or more fastening means for non-rotational fastening and securing to the second pressure plate.

5. The lower chord connection with a connection device according to claim 1, wherein the first fastening member has a second cylindrical lateral surface portion which in particular directly adjoins the second fastening member.

6. The lower chord connection comprising a connection device according to claim 5, wherein a screw threaded portion adjoins the second cylindrical skirt surface portion to fasten the first fastening member to the first pressure plate by screwing.

7. The lower chord connection comprising a connection device according to claim 5, wherein the second cylindrical shell surface portion is provided with an anti-rotation means, formed with a centering pin projecting from the second cylindrical shell surface portion.

8. The lower chord connection with a connection device according to claim 1, wherein the second pressure plate is provided with a continuous second through opening for receiving the centering sleeve in a form-locking and friction-locking manner in the axial and radial direction.

9. The lower chord connection with a connection device according to claim 1, wherein the first pressure plate is provided with a first through-opening for receiving the second lateral surface portion in a form-locking and friction-locking manner in the radial and axial directions, wherein in an assembled state an axial end of a first lateral surface portion of the second fastening part bears against the first pressure plate.

10. The lower chord connection comprising a connection device according to claim 9, wherein the first lateral surface portion has an axial length at least equal to the thickness of the second pressure plate wherein the securing slot is arranged such that, in an assembled state in which the first and second pressure plates abut against each other, a force is exerted against the second pressure plate in the direction of the second fastening part when the plug-in part is inserted.

11. The lower chord connection comprising a connection device according to claim 1, wherein at least one further connection bolt is provided with a first fastening part for fastening to the second pressure plate of the second cantilever segment and with a second fastening part for fastening to the first pressure plate of the first cantilever segment wherein the first fastening member is provided with a releasable connecting means for fastening to the second pressure plate wherein the second fastening part is provided with a centering pin for fastening to the first pressure plate which has a radial, in particular continuous, securing slot for receiving a plug-in part; and
a centering sleeve for inserting into a corresponding through-opening in the first pressure plate which has an internal cross-section for receiving the second fastening part in a form-fitting manner.

12. The lower chord connection comprising a connection device according to claim 1,
wherein the lower chord connection connects two lower chords of the cantilever segments with each other,
wherein a fixing device is provided at the end face of each of the two lower chords in order to secure the lower chords against displacement transversely to their axial direction.

13. The lower chord connection comprising a connection device according to claim 12, wherein the fixing device comprises:
at least one screw mandrel having a first fastening portion for fastening to the first pressure plate and having a second fastening portion for fastening to the second pressure plate,
wherein the second mounting portion having a peripheral surface portion for mounting said mandrel to said second pressure plate,
wherein a bushing is provided for inserting into a through opening in the second pressure plate, and
wherein the bushing has an inner wall to receive the mantle surface portion of the second attachment portion.

14. The lower chord connection with a connection device according to claim 13,
wherein the first fastening portion is provided with a threaded portion for fastening the screw mandrel to a threaded hole in the first pressure plate.

15. The lower chord connection comprising a connection device according to claim 13, wherein the lateral surface portion of the second fastening portion is received in the through-opening in a form-fitting and friction-fitting manner.
